(19) United States
(12) Patent Application Publication
(10) Pub. No.: US 2018/0141855 A1
(43) Pub. Date: May 24, 2018

(54) SUBSTRATE PROVIDED WITH A STACK HAVING THERMAL PROPERTIES, HAVING A METALLIC TERMINAL LAYER AND HAVING AN OXIDIZED PRETERMINAL LAYER

(71) Applicant: SAINT-GOBAIN GLASS FRANCE, Courbevoie (FR)

(72) Inventors: Yann COHIN, Paris (FR); Nicolas MERCADIER, Paris (FR); Benoit GEORGES, Abu Dhabi (AE)

(73) Assignee: SAINT-GOBAIN GLASS FRANCE, Courbevoie (FR)

(21) Appl. No.: 15/577,025

(22) PCT Filed: May 26, 2016
(86) PCT No.: PCT/FR2016/051238

§ 371 Date: Nov. 27, 2017

(30) Foreign Application Priority Data
May 29, 2015 (FR) 1554852

(51) Int. Cl. C03C 17/36; C03C 23/00

(52) U.S. Cl. CPC C03C 17/366; C03C 23/007; C03C 17/3639; C03C 17/3613

(57) ABSTRACT

An substrate is coated on one face with a stack of thin layers including at least one metallic functional layer. The stack includes a terminal layer that is the layer of the stack furthest from the face, which comprises at least one metal M₂ that is a reducing agent in an oxide/metal pair exhibiting an oxidation/reduction potential γ₂ and the terminal layer is in the metallic state. The stack also includes a preterminal layer that is the layer of the stack located immediately under and in contact with the terminal layer in the direction of the face, which comprises at least one metal M₁ that is an oxidizing agent in an oxide/metal pair exhibiting an oxidation/reduction potential γ₁ and the preterminal layer is in the at least partially oxidized state. The oxdiation/reduction potential γ₁ is greater than the oxidation/reduction potential γ₂.

The invention relates to a substrate coated on one face with a stack of thin layers having reflection properties in the infrared region and/or in solar radiation comprising at least one metallic functional layer, in particular based on silver or on silver-containing metal alloy, and at least two antireflective coatings, said coatings each comprising at least one dielectric layer, said functional layer being positioned between the two antireflective coatings, said stack additionally comprising a terminal layer which is the layer of the stack which is furthest from said face.

In this type of stack, the functional layer is thus positioned between two antireflective coatings each generally comprising several layers which are each made of a dielectric material of the nitride type, in particular silicon or aluminum nitride type, or oxide type. From the optical viewpoint, the aim of these coatings, which frame the or each metallic functional layer, is to render this metallic functional layer “antireflective”.

A blocking coating is, however, sometimes inserted between a or each antireflective coating and the metallic functional layer; the blocking coating positioned under the functional layer in the direction of the substrate protects it during a possible high-temperature heat treatment, of the bending and/or tempering type, and the blocking coating positioned on the functional layer on the opposite side from the substrate protects this layer from possible degradation during the deposition of the upper antireflective coating and during a possible high-temperature heat treatment, of the bending and/or tempering type.

The invention relates more particularly to the use of a terminal layer of the stack, that furthest from the face of the substrate on which the stack is deposited, and the implementation of a treatment of the complete stack of thin layers using a source which produces radiation and, in particular infrared radiation.

It is known, in particular from the international patent application No. WO 2010/142926, to provide an absorbent layer as terminal Layer of a stack and to apply a treatment after the deposition of a stack in order to reduce the emissivity or to improve the optical properties of a low-emissive stack. The use of a metallic terminal layer makes it possible to increase the absorption and to reduce the power necessary for the treatment. As the terminal layer oxidizes during the treatment and becomes transparent, the optical characteristics of the, stack after treatment are advantageous (a high light transmittance can in particular be obtained).

However, this solution is not completely satisfactory for certain applications due to the nonuniformity of the sources used for the treatment and/or imperfections of the conveying system, the speed of which is never absolutely constant.

This is reflected by optical nonuniformities perceptible to the eye (variations in light transmittance/reflection and in colors from one point to another).

The aim of the invention is to succeed in overcoming the disadvantages of the prior art by developing a novel type of stack of layers having one or more functional layers, which stack exhibits, after treatment, a low sheet resistance (and thus a low emissivity), a high light transmittance and also a uniformity in appearance, both in transmittance and in reflection.

Another important aim is to make it possible to carry out the treatment more quickly and thus to reduce its cost.

A subject matter of the invention is thus, in its broadest sense, a substrate as claimed in claim 1. This substrate is coated on one face with a stack of thin layers having reflection properties in the infrared region and/or in solar radiation comprising at least one metallic functional layer, in particular based on silver or on silver-containing metal alloy, and at least two antireflective coatings, said coatings each comprising at least one dielectric layer, said functional layer being positioned between the two antireflective coatings, said stack comprising, on the one hand, a terminal layer which is the layer of the stack furthest from said face, which comprises at least one metal M₂, said metal being a reducing agent in an oxide/metal pair exhibiting an oxidation/reduction potential γ₂ and said terminal layer being in the metallic state, and, on the other hand, a preterminal layer which is the layer of the stack located immediately under and in contact with said terminal layer in the direction of said face, which comprises at least one metal M₁, said metal being a reducing agent in an oxide/metal pair exhibiting an oxidation/reduction potential γ₁ and said preterminal layer being in the at least partially oxidized state.

According to the invention, said oxidation/reduction potential γ₁ is greater than said oxidation/reduction potential γ₂, said oxidation/reduction potentials being measured by a standard hydrogen electrode.

As usual, the term “dielectric layer” should be understood as meaning, within the meaning of the present invention, that, from the viewpoint of its nature, the material is “nonmetallic”, that is to say is not a metal. In the context of the invention, this term denotes a material exhibiting an n/k ratio over the entire visible wavelength range (from 380 nm to 780 nm) equal to or greater than 5.

The term “absorbent layer” should be understood as meaning, within the meaning of the present invention, that the layer is a material exhibiting a mean coefficient k, over the entire visible wavelength range (from 380 nm to 780 nm), of greater than 0.5 and exhibiting a bulk electrical resistivity (as known in the literature) of greater than 10⁻⁶ Ω·cm.

It should be remembered that n denotes the true refractive index of the material at a given wavelength and the coefficient k represents the imaginary part of the refractive index at a given wavelength; the ratio n/k being calculated at a given wavelength identical for n and for k.

The term “metallic layer” should be understood as meaning, within the meaning of the present invention, that the layer is absorbent as indicated above and that it does not comprise an oxygen atom or a nitrogen atom.

The “oxidation/reduction potential” is the voltage obtained with the standard hydrogen electrode; this is the potential generally shown in reference works.

The stack according to the invention thus comprises a final layer known as “terminal layer” (or “overcoat”), that is to say a layer deposited in the metallic state from a metal target and in an atmosphere comprising neither oxygen nor nitrogen deliberately introduced. This layer is encountered oxidized essentially stoichiometrically in the stack after the treatment using a source producing radiation and in particular infrared radiation.

Said preterminal layer, in the state at least partially oxidized with respect to its known stable, stoichiometry, acts as an oxygen-donating layer for the layer immediately above (on the opposite side from the substrate).

Said preterminal layer can be in the oxidized state, according to its known stable stoichiometry, indeed even can be in the superoxidized state with respect to its known stable stoichiometry.

Said metallic terminal layer preferably exhibits a thickness of between 0.5 nm and 5.0 nm, preferably between 1.0 nm and 4.0 nm. This relatively low thickness makes it possible to obtain complete oxidation of the terminal layer during the treatment and thus a relatively high light transmittance.

Said terminal layer is chosen in order to exhibit a high absorption at the wavelength λ of the source producing radiation during the treatment. For example, the imaginary part of the index of a metal of the terminal layer k(λ) adheres to: k(λ)>3 (ex.: Ti at 980 nm), preferably k(λ)>4 (ex.: Zn at 980 nm), preferably k(λ)>7 (ex.: Sn, In at 980 nm).

Said preterminal layer preferably exhibits a thickness of between 5.0 and 20.0 nm, preferably between 10.0 nm and 15.0 nm. This relatively moderate thickness makes it possible to produce an effective oxygen reservoir without excessively greatly influencing the optical appearance of the stack.

In a specific alternative form, said metallic terminal layer is made of titanium or is a mixture of zinc and tin SnᵢZnⱼ with an atomic content of tin of 0.1≤i≤0.5 and i+j=1; preferably 0.15≤i≤0.45 and i+j=1.

In a specific alternative form, said preterminal layer is a tin oxide (that is to say, a layer which does not comprise an element other than Sn and O) or an oxide of a mixture of metal elements comprising tin and additionally comprising, preferably, zinc.

In this specific alternative form, said preterminal layer is preferably an oxide of a mixture of zinc and tin SnₓZn_{y} with an atomic content of tin of 0.3≤x<1.0 and x+y=1; preferably 0.5<x<1.0 and x+y=1.

Preferably, when said metallic terminal layer and said preterminal layer both comprise tin and zinc, the atomic proportion of tin with regard to zinc is different and said preterminal. layer is richer in tin than said metallic terminal layer; however, when said metallic terminal layer and said preterminal layer both comprise tin and zinc, the atomic proportion of tin with regard to zinc can be identical for both layers. In a specific version of the invention, said preterminal layer is located directly on a dielectric layer based on silicon nitride, this dielectric layer based on silicon nitride preferably not comprising oxygen. This dielectric layer based on silicon nitride preferably exhibits a physical thickness of between 5.0 and 50.0 nm, preferably between 8.0 and 20.0 nm, this layer preferably being made of silicon nitride Si₃N₄ doped with aluminum.

This dielectric layer based on silicon nitride is a barrier layer which prevents the penetration of oxygen coming from the atmosphere in the direction of the substrate; as the metallic functional layer is located between this barrier layer and the substrate, it prevents the penetration of oxygen coming from the atmosphere in the direction of the metallic functional layer.

In addition, it is assumed that such a dielectric layer based on silicon nitride immediately under the preterminal layer in the direction of the substrate prevents the oxygen of this preterminal layer from migrating in the direction of the substrate during the treatment and thus promotes the migration of the oxygen of this preterminal layer in the opposite direction, that is to say in the direction of the terminal layer.

A dielectric layer based on silicon nitride is difficult to deposit as the silicon is difficult to sputter as a result of its low conductivity. The presence of the preterminal layer makes it possible in addition to deposit a dielectric layer based on silicon nitride with a lower thickness than normal.

In another specific version of the invention, the functional layer is deposited directly on a blocking undercoating positioned between the functional layer and the dielectric coating underlying the functional layer and/or the functional layer is deposited directly under a blocking overcoating positioned between the functional layer and the dielectric coating overlying the functional layer, and the blocking undercoating and/or the blocking overcoating comprises a thin layer based on nickel or titanium exhibiting a physical thickness such that 0.2 nm≤e′≤2.5 nm.

The invention additionally relates to a process for obtaining a substrate coated on one face of a stack of thin layers having reflection properties in the infrared region and/or in solar radiation comprising at least one metallic functional layer, in particular based on silver or on silver-containing metal alloy, and two antireflective coatings, comprising the following stages, in order:

the deposition on one face of said substrate of a stack of thin layers having reflection properties in the infrared region and/or in solar radiation comprising at least one metallic functional layer, in particular based on silver or on silver-containing metal alloy, and at least two antireflective coatings, according to the invention,

the treatment of said stack of thin layers using a source producing radiation and in particular infrared radiation, said terminal layer being at least partially oxidized after said treatment.

By virtue of the preterminal layer, it is possible for said treatment to be carried out in an atmosphere not comprising oxygen.

In addition, it is possible to provide a multiple glazing comprising at least two substrates which are held together by a frame structure, said glazing producing a separation between an external space and an internal space, in which at least one inserted gas-filled cavity is positioned between the two substrates, one substrate being according to the invention.

Preferably, just one substrate of the multiple glazing comprising at least two substrates or of the multiple glazing comprising at least three substrates is coated on an internal face in contact with the inserted gas-filled cavity with a stack of thin layers having reflection properties in the infrared region and/or in solar radiation.

The glazing then incorporates at least the substrate carrying the stack according to the invention, optionally in combination with at Least one other substrate.

It is also possible, in a multiple glazing comprising three substrates, for two substrates to be each coated on an internal face in contact with the inserted gas-filled cavity with a stack of thin layers having reflection properties in the infrared region and/or in solar radiation according to the invention.

Each substrate can be clear or colored. At least one of the substrates in particular can be made of glass colored in its body. The choice of the type of coloring will depend on the light transmittance level and/or on the calorimetric appearance which are desired for the glazing once its manufacture is complete.

The glazing can exhibit a laminated structure, combining in particular at least two rigid substrates of the glass type with at least one sheet of thermoplastic polymer, in order to exhibit a structure of glass/stack of thin layers/sheet(s)/glass/inserted gas-filled cavity/glass sheet type. The polymer can in particular be based on polyvinylbutyral PVB, ethylene/vinyl acetate EVA, polyethylene terephthalate PET or polyvinyl chloride PVC.

Advantageously, the present invention thus makes it possible to produce a stack of thin layers having one or more functional layers exhibiting a low emissivity (in particular ≤1%) and a high solar factor which exhibits a homogeneous optical appearance in transmittance and in reflection after treatment of the stack using a source producing radiation and in particular infrared radiation.

For the ranges of thicknesses indicated in the present document, the top and bottom limits of these ranges are included in these ranges.

The advantageous characteristics and details of the invention emerge from the following nonlimiting examples, illustrated using the appended figures, which illustrate:

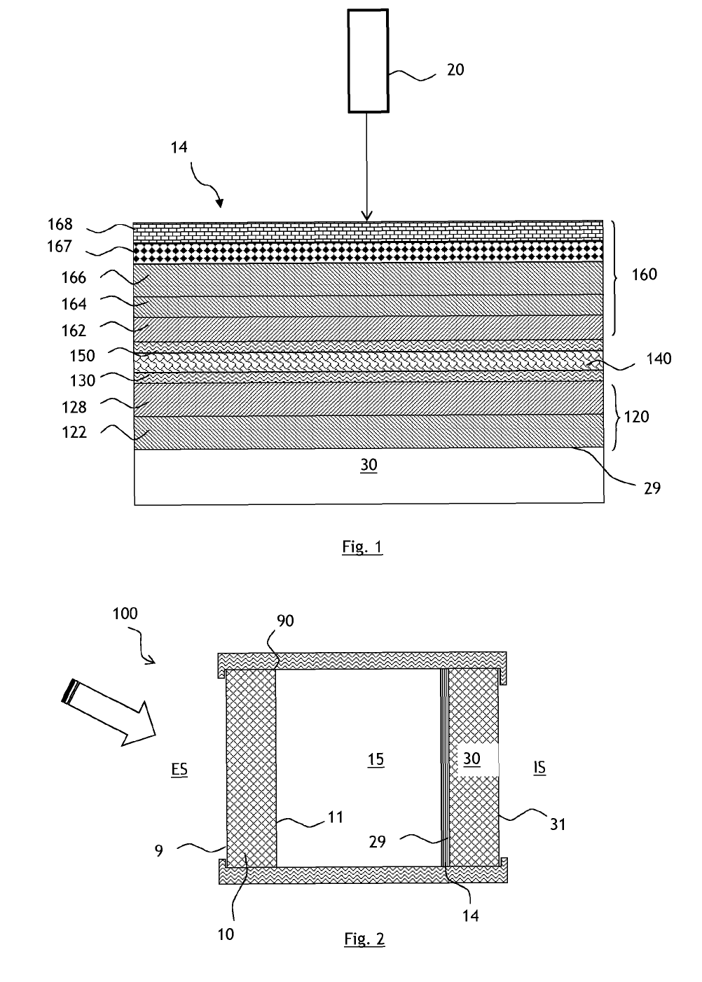

in FIG. 1, a functional monolayer stack according to the invention, the functional layer being deposited directly on a blocking undercoating and directly under a blocking overcoating, the stack being illustrated during the treatment using a source producing radiation;

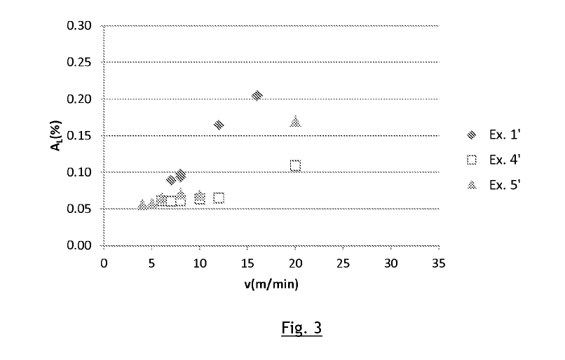

in FIG. 2, a double glazing solution incorporating a functional monolayer stack; and

in FIG. 3, the light absorption A_{L}, as percent, of the three series of examples 1′, 440 and 5′, as a function of the rate r of treatment, in meters per minute.

In FIGS. 1 and 2, the proportions between the thicknesses of the different layers or of the different elements are not rigorously observed, in order to facilitate the reading thereof.

FIG. 1 illustrates a structure of a functional monolayer stack 14 according to the invention deposited on a face 29 of a transparent glass substrate 30, in which the single functional layer 140, in particular based on silver or on silver-containing metal alloy, is positioned between two antireflective coatings, the underlying antireflective coating 120 located below the functional layer 140 in the direction of the substrate 30 and the overlying antireflective coating 160 positioned above the functional layer 140 on the opposite side from the substrate 30.

These two antireflective coatings 120, 160 each comprise at least one dielectric layer 122, 128; 162, 164, 166.

Optionally, on the one hand, the functional layer 140 can be deposited directly on a blocking undercoating 130 positioned between the underlying antireflective coating 120 and the functional layer 140 and, on the other hand, the functional layer 140 can be deposited directly under a blocking overcoating 150 positioned between the functional layer 140 and the overlying antireflective coating 160.

The underblocker and/or overblocker layers, although deposited in the metallic form and presented as being metallic layers, are sometimes in practice oxidized layers as one of their functions (in particular for the overblocker layer) is to oxidize during the deposition of the stack in order to protect the functional layer.

The antireflective coating 160 located above the metallic functional layer (or which would be located above the metallic functional layer furthest from the substrate if there were several metallic functional layers) terminates in a terminal layer 168, which is the layer of the stack which is furthest from the face 29.

In addition, a preterminal layer 167 is provided immediately under this terminal layer 168, in the direction of the face 29, this preterminal layer 167 being in contact with the terminal layer located above.

When a stack is used in a multiple glazing 100 of double glazing structure, as illustrated in FIG. 2, this glazing comprises two substrates 10, 30 which are held together by a frame structure 90 and which are separated from one another by an inserted gas-filled cavity 15.

The glazing thus produces a separation between an external space ES and an internal space IS.

The stack can be positioned as face 3 (on the innermost sheet of the building on considering the incident direction of the sunlight entering the building and on its face directed towards the gas-filled cavity).

FIG. 2 illustrates this positioning (the incident direction of the sunlight entering the building being illustrated by the double arrow) as face 3 of a stack of thin layers 14 positioned on an internal face 29 of the substrate 30 in contact with the inserted gas-filled cavity 15, the other face 31 of the substrate 30 being in contact with the internal space IS.

However, it can also be envisaged, in this double glazing structure, for one of the substrates to exhibit a laminated structure.

Six examples were carried out on the basis of the stack structure illustrated in FIG. 1 and were numbered from 1 to 6.

For these examples 1 to 6, the antireflective coating 120 comprises two dielectric layers 122, 128; the dielectric layer 122, in contact with the face 29, is a layer having a high refractive index and it is in contact with a dielectric wetting layer 128 positioned immediately under the metallic functional layer 140.

In examples 1 to 6, there is no blocking undercoating 130.

The dielectric layer 122 having a high refractive index is based on titanium oxide; it exhibits a refractive index of between 2.3 and 2.7 and which is in this instance precisely 2.46.

For examples 1 to 6, the dielectric layer 128 is known as “wetting layer” as it makes it possible to improve the crystallization of the metallic functional

Layer 140, which is in this instance made of silver, which improves its conductivity. This dielectric layer 128 is made of zinc oxide ZnO (deposited from a ceramic target consisting of 50 atom % of zinc and 50 atom % of oxygen).

The overlying antireflective coating 160 comprises a dielectric layer 162 made of zinc oxide (deposited from a ceramic target consisting of 50 atom % of doped zinc and 50 atom % of oxygen) and then a dielectric layer 164 having a high index, made of the same material as the dielectric layer 122.

The following dielectric layer 166 is made of nitride, of Si₃N₄:Al, and is deposited from a metal target made of Si doped to 8% by weight with aluminum.

For all the examples below, the conditions for deposition of the layers are:

| | | Deposition | |
|---|---|---|---|
| Layer | Target employed | pressure | Gas |
| Si₃N₄:Al | Si:Al at 92:8 wt % | 1.5 × 10⁻³ mbar | 45% Ar/(Ar + N₂) |
| TiO₂ | TiO₂ | 2 × 10⁻³ mbar | 90% Ar/(Ar + O₂) |
| Ti | Ti | 7 × 10⁻³ mbar | 100% Ar |
| ZnO | Zn:O at 50:50 | 2 × 10⁻³ mbar | 90% Ar/(Ar + O₂) |
| | atom % | | |
| SnO₂ | Sn | 2 × 10⁻³ mbar | 90% Ar/(Ar + O₂) |
| SnᵢZnⱼ | Sn:Zn at 19:81 | 7 × 10⁻³ mbar | 100% Ar |
| | atom % | | |
| SnₓZn_{y}O_{z} | Sn:Zn at 45:55 | 2 × 10⁻³ mbar | 90% Ar/(Ar + O₂) |
| | atom % | | |
| Ag | Ag | 2 × 10⁻³ mbar | 100% Ar |

The layers deposited can thus be classified into four categories:

i—layers made of antireflective/dielectric material, exhibiting an n/k ratio over the entire visible wavelength range of greater than 5: Si₃N₄, TiO₂, ZnO, SnO₂, SnₓZn_{y}O_{z},

ii—metallic layer made of absorbent material, exhibiting a mean coefficient k, over the entire visible wavelength range, of greater than 0.5 and a bulk electrical resistivity which is greater than 10⁻⁶ Ω·cm: SnᵢZnⱼ, Ti,

iii—metallic functional layers made of material having properties of reflection in the infrared region and/or in solar radiation; Ag,

iv—underblocker and overblocker layers intended to protect the functional layer from modification of its nature during the deposition of the stack; their influence on the optical and energy properties is generally not known.

It has been found that silver exhibits a ratio 0<n/k <5 over the entire visible wavelength range but its bulk electrical resistivity is less than 10⁻⁶ Ω·cm.

In all the examples below, the stack of thin layers is deposited on a substrate made of clear soda-lime glass with a thickness of 4 mm on the Planiclear brand, distributed by Saint-Gobain.

For these substrates:

R indicates the sheet resistance of the stack, in ohms per square;

A_{L} indicates the light absorption in the visible region in %, measured according to the D65 illuminant;

I_{T} indicates the optical inhomogeneities in transmittance; it involves a grade of 1, 2, 3 or 4, assigned by an operator: the grade 1 when no inhomogeneity is perceptible to the eye, the grade 2 when localized inhomogeneities, limited to certain regions of the sample, are perceptible to the eye under intense diffuse illumination (>800 lux), the grade 3 when localized inhomogeneities, limited to certain regions of the sample, are perceptible to the eye under standard illumination (<500 lux) and the grade 4 when inhomogeneities spread over the entire surface of the sample are perceptible to the eye under standard illumination (<500 lux).

I_{R} indicates the optical inhomogeneities in reflection; it involves a grade of 1, 2, 3 or 4, assigned by an operator: the grade 1 when no inhomogeneity is perceptible to the eye, the grade 2 when localized inhomogeneities, limited to certain regions of the sample, are perceptible to the eye under intense diffuse illumination (>800 lux), the grade 3 when localized inhomogeneities, limited to certain regions of the sample, are perceptible to the eye under standard illumination (<500 lux) and the grade 4 when inhomogeneities spread over the entire surface of the sample are perceptible to the eye under standard illumination (<500 lux).

All these examples make it possible to achieve a low emissivity, of the order of 1%, and a high g factor, of the order of 60%.

The geometric or physical thicknesses (and not the optical thicknesses) in nanometers, with reference to FIG. 1, of each of the layers of examples 1 to 6 are illustrated in table 1 below:

TABLE 1

| Layer | Material | Ex. 1, 3 | Ex. 2, 4-6 |
|---|---|---|---|
| 168 | | variable | variable |
| 167 | | variable | variable |
| 166 | Si₃N₄:Al | 25 | 15 |
| 164 | TiO₂ | 12 | 12 |
| 162 | ZnO | 1 | 4 |
| 150 | Ti | 0.4 | 0.4 |
| 140 | Ag | 13.5 | 13.5 |
| 128 | ZnO | 4 | 4 |
| 122 | TiO₂ | 24 | 24 |

The materials tested for the terminal layers 168 and optionally the preterminal layers 167 of examples 1 to 6, and also their respective thicknesses (in nm), are presented in table 2 below:

TABLE 2

| Layer | Ex. 1 | Ex. 2 | Ex. 3 | Ex. 4 | Ex. 5 | Ex. 6 |
|---|---|---|---|---|---|---|
| 168 | SnᵢZnⱼ | SnᵢZnⱼ | Ti | SnᵢZnⱼ | SnᵢZnⱼ | Ti |
| Thickness | 4.5 | 4.5 | 3 | 4.5 | 4.5 | 3 |
| 167 | — | TiO₂ | — | SnₓZn_{y}O_{z} | SnO₂ | SnₓZn_{y}O_{z} |
| Thickness | | 15 | | 15 | 15 | 15 |

It should be remembered that the oxidation/reduction potentials, measured by a standard hydrogen electrode:
for the Ti/TiO₂ pair: −1.63 V
for the Zn/ZnO pair: −0.76 V
for the Sn/SnO₂ pair: −0.13 V.

For examples 4 to 6, on the one hand, the terminal layer 168 in the metallic state before the treatment comprises at least one metal M₂ (Zn, Ti) which is a reducing agent in an oxide/metal pair exhibiting an oxidation/reduction potential γ₂ and, on the other hand, the preterminal layer 167 comprises at least one metal M₁ (Sn) which is an oxidizing agent in an oxide/metal pair exhibiting an oxidation/reduction potential γᵢ, and the oxidation/reduction potential γ₁ is thus greater than the oxidation/reduction potential γ₂.

The preterminal layer 167 of examples 4 and 6 is an oxide of a mixture of zinc and tin SnₓZn_{y} with an atomic content of tin of 0.3≤x≤1.0 and x+y=1, and specifically x=0.45 and y=0.55.

The preterminal layer 167 of example 5 is a tin oxide deposited in its stable stoichiometric form SnO₂.

The preterminal layer 167 of example 2 is a titanium oxide deposited in its stable stoichiometric form TiO₂.

The terminal layer 168 of examples 1, 2, 4 and 5 is a metallic layer consisting of zinc and tin, as SnᵢZnⱼ, with an atomic content of tin of 0.1≤i≤0.5 and i+j=1, and specifically i=0.19 and j=0.81.

The terminal layer 168 of examples 3 and 6 is a metallic layer consisting of titanium.

The main optical and energy characteristics of these examples 1 to 6, respectively before treatment (BT) and after treatment (AT), are summarized in table 3 below;

TABLE 3

| | | A_{L} | R | I_{T} | I_{R} |
|---|---|---|---|---|---|
| Ex. 1 | BT | 41.6 | 2.62 | | |
| | AT | 16.5 | 2.06 | 3 | 2 |
| Ex. 2 | BT | 41.0 | 2.61 | | |
| | AT | 16.0 | 2.05 | 3 | 3 |
| Ex. 3 | BT | 28.3 | 2.68 | | |
| | AT | 18.3 | 2.17 | 2 | 2 |
| Ex. 4 | BT | 40.5 | 2.66 | | |
| | AT | 6.4 | 2.06 | 1 | 1 |
| Ex. 5 | BT | 34.0 | 2.65 | | |
| | AT | 6.8 | 2.16 | 1 | 1 |
| Ex. 6 | BT | 31.5 | 2.24 | | |
| | AT | 12.3 | 2.14 | 1 | 1 |

For examples 1 to 6, the presence of the terminal layer 168, which is metallic before treatment, results in a relatively high absorption A_{L} at 980 nm (of the order of 30 to 40%), due to the metallic state of these terminal layers before the treatment.

The treatment consists in this instance of a forward progression of the substrate 30 at a rate of 10 m/min under a laser line 20 with a width of 60 μm and a power of 25 W/mm with the laser line oriented perpendicularly to the face 29 and in the direction of the terminal layer 168, that is to say by positioning the laser line (illustrated by the straight black arrow) above the stack and by orienting the laser in the direction of the stack, as visible in FIG. 1.

The decrease in sheet resistance in the treatment of examples 1 to 3 is of the order of 20%, which is a good result.

The decrease in sheet resistance in the treatment of example 4 is excellent: 22.5%; the decrease in sheet resistance in the treatment of examples 5 and 6 is not quite so good (respectively 18.4% and 15.7%), while being satisfactory; the emissivity obtained after treatment is low, as desired.

After treatment and oxidation of the terminal layer 168, examples 1 to 3 exhibit an excessively high light absorption A_{L} (greater than 15%) and are not optically sufficiently homogeneous, both in transmittance and in reflection, with I_{T} and I_{R} values equal to or greater than 2.

After treatment and oxidation of the terminal layer 168, examples 4 and 5 exhibit an excellent light absorption A_{L} (of the order of 6.5%) and are optically very homogeneous, both in transmittance and in reflection, with I_{T} and I_{R} values equal to 1.

After treatment and oxidation of the terminal layer 168, example 6 exhibits a light absorption A_{L} which is a little bit high but is optically very homogeneous, both in transmittance and in reflection, with I_{T} and I_{R} values equal to 1.

Surprisingly, by choosing the preterminal layer according to the invention, despite the presence of oxygen in this layer, the preterminal layer promotes optical stability, both in transmittance and in reflection.

On the basis of examples 1, 4 and 5, a series of tests was carried out using the same stacks (same materials for layers, same thicknesses) as for examples 1, 4 and 5 but treating them at different treatment rates r; these series are respectively denoted examples 1′, examples 4′ and examples 5′ in FIG. 3.

This FIG. 3 shows that the absorption A_{L} after treatment is lower for examples 4′ and 5′ with a preterminal layer according to the invention under the terminal layer than for examples 1′ without a preterminal layer according to the invention under the terminal layer, whatever the treatment rate r.

In addition, FIG. 3 shows that it is possible to increase the treatment rate by 20% to 50% for examples 4′ and 5′, up to values of approximately 15 m/minute, without this actually influencing the low absorption after treatment.

The present invention can also be used for a stack of thin layers having several functional layers. The terminal layer according to the invention is the layer of the stack which is furthest from the face of the substrate on which the stack is deposited and the preterminal layer is the layer located immediately under the terminal layer in the direction of the face of the substrate on which the stack of thin layers is deposited and in contact with the terminal layer.

The present invention is described in that which precedes by way of example, It is understood that the person skilled in the art is in a position to produce different alternative forms of the invention without, however, departing from the scope of the patent as defined by the claims.

1-10. (canceled)

11. A substrate coated on one face with a stack of thin layers having reflection properties in the infrared region and/or in solar radiation comprising at least one metallic functional layer and at least two antireflective coatings, said coatings each comprising at least one dielectric layer, said functional layer being positioned between the two antireflective coatings, said stack comprising:
a terminal layer that is the layer of the stack furthest from said face, which comprises at least one metal M₂, said metal being a reducing agent in an oxide/metal pair exhibiting an xidation/reduction potential γ₂ and said terminal layer being in the metallic state, and
a preterminal layer that is the layer of the stack located immediately under and in contact with said terminal layer in the direction of said face, which comprises at least one metal M₁, said metal being a reducing agent in an oxide/metal pair exhibiting an oxidation/reduction potential γ₁ and said prete iinal layer being in the at least partially oxidized state,
wherein said oxidation; eduction potential γ₁ is greater than said oxidation/reduction potential γ₂, said oxidation/reduction potentials being measured by a standard hydrogen electrode.

12. The substrate as claimed in claim 11, wherein the at least one metallic functional layer is based on silver or on silver-containing metal alloy.

13. The substrate as claimed in claim 11, wherein said metallic terminal layer exhibits a thickness of between 0.5 nm and 5.0 nm.

14. The substrate as claimed in claim 11, wherein said metallic terminal layer exhibits a thickness of between 1.0 nm and 4.0 nm.

15. The substrate as claimed in claim 11, wherein said preterminal layer exhibits a thickness of between 5.0 and 20.0 nm.

16. The substrate as claimed in claim 11, wherein said preterminal layer exhibits a thickness of between 10.0 nm and 15.0 nm.

17. The substrate as claimed in claim 11, wherein said metallic terminal layer is made of titanium or is a mixture of zinc and tin SnᵢZnⱼ with an atomic content of tin of 0.1≤i≤0.5 and i+j=1.

18. The substrate as claimed in claim 11. wherein said metallic terminal layer is made of titanium or is a mixture of zinc and tin SnᵢZnⱼ with an atomic content of tin of 0.15≤i≤0.45 and i+j=1.

19. The substrate as claimed in claim 11, wherein said preterminal layer is a tin oxide or an oxide of a mixture of metal elements comprising tin.

20. The substrate as claimed in claim 11, wherein said preterminal layer is a tin oxide or an oxide of a mixture of metal elements comprising tin and zinc.

21. The substrate as claimed in claim 20, wherein said preterminal layer is an oxide of a mixture of zinc and tin SnₓZn_{y} with an atomic content of tin of 0.3≤x<1.0 and x+y=1.

22. The substrate as claimed in claim 20, wherein said preterminal layer is an, oxide of a mixture of zinc and tin SnₓZn_{y} with an atomic content of tin of 0.5<x<1.0 and x+y=1.

23. The substrate as claimed in claim 11, wherein said preterminal layer is located, starting from the substrate, on a dielectric layer based on silicon nitride that exhibits a physical thickness of between 5.0 and 50.0 nm.

24. The substrate as claimed in claim 11, wherein said preterminal layer is located, starting from the substrate, on, a dielectric layer based on silicon nitride that exhibits a physical thickness of between 8.0 and 20.0 nm.

25. A multiple glazing comprising:
at least two substrates which are held together by a frame structure, said glazing producing a separation between an external space and an internal space, in which at least one inserted gas-filled cavity is positioned between the two substrates, and one of the two substrates being the substrate as claimed in claim 11.

26. A process for obtaining a substrate coated on one face of a stack of thin layers having reflection properties in the infrared region and/or in solar radiation comprising at least one metallic functional layer and two antireflective coatings, the, process comprising the following, in order:
depositing, on one face of said substrate, a stack of thin layers having reflection properties in the infrared region and/or in solar radiation comprising at least one metallic functional layer and at least two antireflective coatings, said substrate being the substrate as claimed in claim 11; and
treating said.stack of thin layers using a source producing radiation, said terminal layer being at least partially oxidized after said treatment.

27. The process as claimed in claim 26, wherein the at least one metallic functional layer is based on silver or n silver-containing metal alloy.

28. The process as claimed in claim 26, wherein the source produces infrared radiation.

29. The process as claimed in claim 26, wherein said treatment is carried out in an atmosphere not comprising oxygen.
